(19) United States
(12) Patent Application Publication
(10) Pub. No.: US 2007/0216782 A1
(43) Pub. Date: Sep. 20, 2007

(54) Method of processing and storing files in a digital camera

(76) Inventor: Donald Lee Chernoff, Vienna, VA (US)

Correspondence Address: i4e, LLC (Attn: Paul L. Ratcliffe, Esq.), 42870 Meander Crossing Court, Ashburn, VA, 20148, US

(21) Appl. No.: 11/704,911

(22) Filed: Feb. 12, 2007

Related U.S. Application Data
(60) Provisional application No. 60/783,716, filed on Mar. 20, 2006.

(51) Int. Cl. H04N 5/76

(52) U.S. Cl. 348/231.99

(57) ABSTRACT

An improved method for processing and storing files in a digital camera is provided which processes multiple image formats and styles simultaneously or sequentially on the camera. The method enables the user to automatically process and store on the camera a small image file sized for sending electronically while simultaneously or sequentially processing and storing on the camera a high quality high resolution image file thereby minimizing post-processing.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

This application claims the benefit or U.S. Provisional Patent Application 60/783,716 filed on Mar. 20, 2006, the entirety of which is incorporated herein by reference.

### FIELD OF THE INVENTION

This invention relates to digital cameras and to the storage method and format of photographs taken by digital cameras.

### BACKGROUND OF THE INVENTION

Digital cameras have the ability to save images to files in various formats and various resolutions. The typical file format used by digital camera manufacturers is called JPEG, which is a common compression method for images and can be read by most if not all image processing software found in personal computers and non-PC image display devices. JPEG stands for Joint Photographic Experts Group with was the name of the committee which created the compression standard.

The JPEG compression, like several other compression techniques, provides for lossy compression and specifies both the codec and the file format. The codec defines how an image is transformed into a stream of data bytes. The file format is called the JPEG interchange format and it is the most used file format for storing and transmitting photographs on the World Wide Web.

There are numerous other types of image compression techniques and methods. Image compression techniques include both lossy and lossless methods. Lossless compression techniques include: Run-length encoding; entropy encoding; and adaptive algorithms such as the LZW algorithm. Lossy compression techniques include: color space coding, chroma sub-sampling, transform coding, and fractal compression. Other image file formats include: TIFF (Tagged Image File Format); RAW, PNG, GIF, BMP, WDP, XPM, and MrSID.

More sophisticated cameras of the single lens reflex (SLR) design typically use a proprietary RAW format which is preferred by professional photographers who desire higher image quality and more control over image quality in post-processing. Since each manufacturer's RAW format is unique, special software is required to read these files. Such software is not always available on all personal computers or image display devices beyond not only the photographer's equipment, but also others that he shares the photos with, therefore it is often more convenient, for the purpose of viewing the images on such devices, for the camera to store images in the JPEG format.

Most of the higher end SLR type cameras offer the option of saving an image in the proprietary raw format of its manufacturer, in the more standard JPEG format, or simultaneously in both RAW and JPEG formats. The purpose of saving each photograph in these two distinct formats simultaneously is that it provides the photographer with more flexibility. Each photograph is stored in the RAW format for the highest quality and highest degree of post-processing flexibility, while the JPEG of the same image is more readily available for simple tasks like viewing on a computer or other display device that may only be able to read JPEG files.

JPEG files are also required for sending as an e-mail since e-mail software typically cannot read the various RAW formats of each camera manufacturer. Another reason for the simultaneous saving of RAW and JPEG files is that RAW files from high-end SLR type cameras are very large files, typically 4 megabytes and larger. Such large files, even if they could be read and displayed by e-mail software are simply too large to send by e-mail and would take too long to send and retrieve. Furthermore, if such large files could be sent by e-mail they would not be viewable in their entirety by the person reading the e-mail because the resolution of the image exceeds the resolution of the computer screen on which the e-mail is viewed. Files sent by e-mail that are larger than the resolution of the screen on the PC where the e-mail will be viewed are often truncated and the whole image cannot be viewed at one time and the viewer must pan the image on the screen to see all of it. This is also a problem for the high quality JPEG files created by any digital camera, since it is a function of image size, not file format.

It may appear that selecting the RAW+JPEG mode in a digital SLR camera and setting the JPEG mode to its smallest size would solve the problem of having to post-process images before e-mailing them. However, the small JPEG files saved in these SLR cameras are also too large to conveniently send in an e-mail, so they too require post-processing to reduce them to a size that can be quickly sent by e-mail and can be easily viewed with e-mail software. For example, on a mid-level digital SLR camera manufactured by the largest manufacturer of such cameras, the smallest simultaneous JPEG file that can be stored along with a RAW file is 1728×1152 pixels in the X and Y dimensions. Typical display resolutions for personal computer monitors range from 800×600 pixels in low end models, to 1280×1024 in high end displays, with a pixels per inch resolution of 72. It is clear that even using a high resolution PC monitor, such an image sized to 1728×1152 would not fit completely on the screen. A JPEG image of these dimensions also creates a file approximately 0.33 Megabytes in size. While this is a considerable size reduction from the original RAW file, it is still on the large end of a file that can be quickly e-mailed. If the photographer is e-mailing multiple images it is advantageous to keep the file sizes to a minimum so that a large quantity of files can be easily sent without overwhelming the e-mail system, especially if the sender or the end user has a slow internet connection.

Some photographers with high-end SLR type cameras prefer to not use RAW image storage but instead shoot in high quality JPEG mode. No digital SLRs have the option of saving a high quality JPEG file and simultaneously save a small JPEG file for the purposes of e-mailing, therefore if the photographer wishes to e-mail photographs, the resulting large JPEG files must also be post-processed to reduce their size so they can be easily sent by e-mail.

Most consumer level “point and shoot” digital cameras normally only save their images as JPEG files so they do not encounter the problem of file compatibility with viewing on a computer or sending and displaying in e-mail software. But even though the higher quality JPEG files created by point-and-shoot cameras are smaller than the RAW files created by high-end SLR cameras, they are still large files that are cumbersome to send and view in an e-mail for the reasons already mentioned. Many point-and-shoot cameras offer a low resolution image setting, typically 640×480 pixels, which is a suitable file size for sending in an e-mail but not suitable for printing or enlarging. Therefore, to obtain a high quality image file and a smaller file of that same image suitable for e-mailing, the user of a point-and-shoot camera must also save images at a high resolution setting and post-process the images to reduce their size so that they can be conveniently sent by e-mail.

Furthermore, point-and-shoot cameras do not typically offer the option of saving files simultaneously in two file sizes. Therefore the photographer has two options: 1) shoot in high quality JPEG mode and post-process as previously discussed. Unfortunately, for most people who are not technically sophisticated, they may not have the time, skills and/or software required to convert files for sending in e-mails. 2) Shoot in very low quality JPEG mode that may or may not be of a size suitable for sending in e-mail. This is a technically simpler option than reducing the size of a high quality JPEG file, but selecting a small file size initially results in image files that do not have enough data to make high quality prints or enlargements.

The typical process for creating images suitable for sending by e-mail is to download the images from the camera into a computer. Image processing software is then used to open the image file and convert it to a size suitable for viewing on a screen and sending via e-mail. Many software programs offer a feature called “save for web” or “save for e-mail” in which the image file is converted to the typical screen resolution of about 72 pixels per inch, sometimes called dots per inch and abbreviated “dpi”. The user then has the option of further reducing the size of the image by altering the x and y dimensions of the image. When changing the size of an image it is desirable to keep the ratio of the x and y dimensions, typically called the aspect ratio, fixed to avoid distorting the image. With the aspect ratio fixed the user only has to choose one dimension and the other will change automatically to keep the aspect ratio from changing. In this way the user can specify the length of the X-axis and have the Y-axis change automatically, or vice versa. Additionally, transferring large images using wireless or cellular communication could occur directly from a camera, but has many upstream wireless connectivity limitations that further restrict the number of files that can be transferred in a reasonable time. All these file size issues need to be addressed to successfully shrink a large JPEG file down to the proper size for sending electronically such as in an e-mail.

To summarize, all modern digital cameras allow the user to select the image quality, and corresponding file size, of the photograph being taken. Most high-end cameras have no setting small enough to produce a file suitable for e-mailing, and if they did the image quality would be too poor to print. Currently, no camera on the market offers the option of selecting a high quality and a low quality JPEG file (or secondary file format) for simultaneous or sequential processing on the camera. The only option currently available to photographers wishing to capture high quality images and be able to send photographs by e-mail is to spend time post-processing their image files so they are compatible with e-mail systems and software.

Therefore, what is needed is a digital camera which captures an image and simultaneously or sequentially processes and saves the captured images in multiple formats and/or styles including a high quality image file and an image file optimized for e-mail or internet transmission in addition to other formats.

### SUMMARY OF INVENTION

Accordingly, the present invention is directed to a digital camera capable of capturing an image and simultaneously or sequentially processing and saving the image in both a first or high quality format and a second or e-mail format.

The present invention provides a method of processing and storing images on a digital camera enabling the user to retain both high quality image files and image files ideal for electronic transmission making it much more convenient to send the image files by e-mail. The digital camera can be programmed by the user to automatically save a high-quality image file and simultaneously or sequentially save a second copy of the same file in a format and file size suitable for electronic transmission such as e-mail.

Accordingly, the present invention provides a digital camera comprising an image sensor for capturing an image and producing an image signal of the image; an analog-to-digital converter for digitizing the image signal to produce a raw digital image; an internal memory for storing at least one digital image; and a processor for compressing the raw digital image into a first format digital image and storing the first format digital image on the internal memory and for compressing the raw digital image into a second format digital image and storing the second format digital image on the internal memory. The camera could include a display coupled to the internal memory for displaying the digital images and would include a user interface for selecting the first format and the second format. The processor could process the first format digital image and second format digital image simultaneously or sequentially or one aspect of the first format digital image and second format digital image simultaneously or sequentially. The processor might also apply a first file name to the first format digital image and a second file name to the second format digital image. The camera could include a format selectable by the user which is formatted for electronic transmission over a communication line or for wireless transmission to a computer. The user interface could include a a file management unit which can delete the first format digital image and the second format digital image through one user selection.

The present invention also provides a method for capturing, processing and storing digital images on a digital camera comprising the steps of: capturing an image and producing an image signal representative of the image; converting the analog image signal into a raw digital image; determining a first format and a second format from user selected format options; processing the raw digital image into a first format digital image and a second format digital image; naming the first format digital image with a first name and the second format digital image with a second name; and storing the first format digital image and the second format digital image on a memory in the camera. Further steps could include wirelessly transmitting at least one of the first format digital image or the second format digital image to a computer or electronically transmitting at least one of the first format digital image or the second format digital image over the internet. The second format digital image could be processed simultaneously with the processing of the first format digital image or could processed after the processing of the first format digital image. An additional processing step could be applied to the first format digital image or the second format digital image. The method could also include the step of deleting the first format digital image and the second format digital image from instructions based on one user selected option.

Other objects and advantages of the present invention will become apparent from the following descriptions wherein an embodiment of the present invention is disclosed.

### BRIEF DESCRIPTION OF DRAWINGS

The accompanying drawings, which are included to provide a further understanding of the invention, are incorporated herein, and constitute a part of this specification and illustrate embodiments of the invention. The figures with the description serve to explain the principles of the invention.

FIG. 1 is a block diagram of the system of the present invention.

FIG. 2 is a flowchart showing the multiple format image processing steps of the present invention.

### DETAILED DESCRIPTION

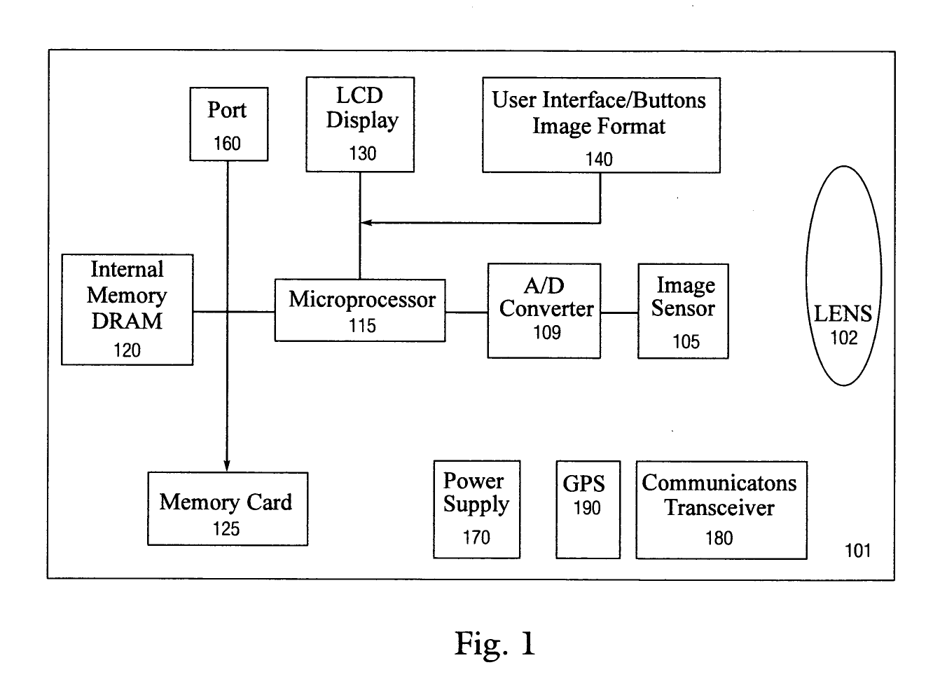

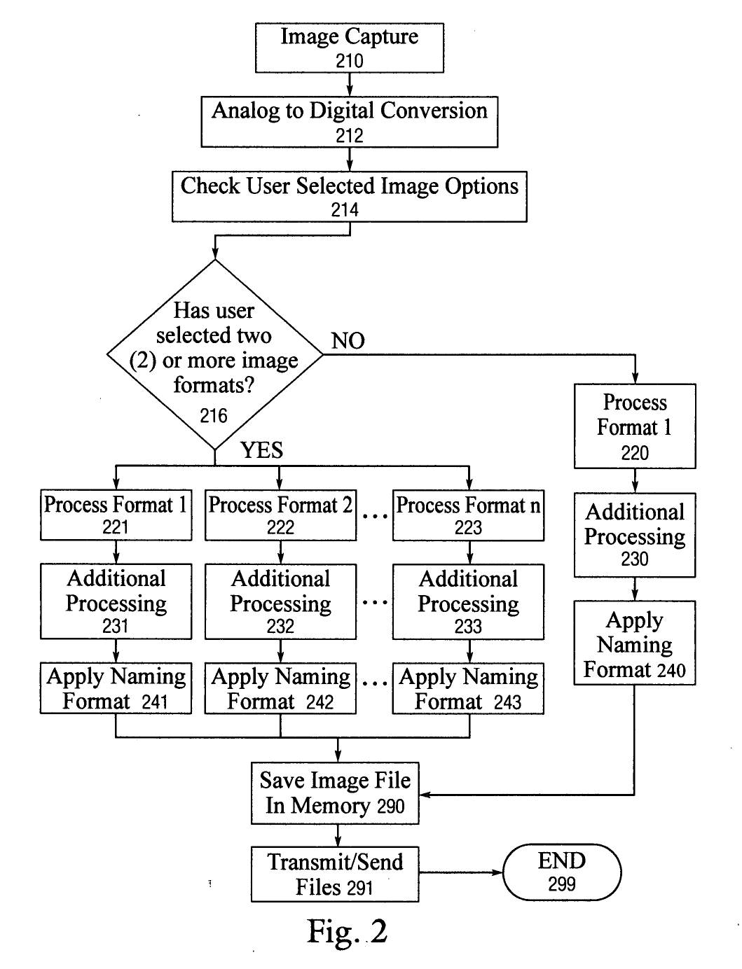

The system of the present invention will now be described in conjunction with FIGS. 1-2.

Digital cameras and digital video recorders are well known and, therefore, the detailed description will be directed to aspects and elements forming part of, or cooperating more directly with, the present invention. Those elements not specifically shown or described herein may be selected from those known in the art. Many of the aspects of the present description may also be implemented in software using known programming languages.

FIG. 1 provides a block diagram of the digital camera 101 of the present invention and includes a lens or optical device 102, an image sensor 105, an analog to digital converter 109, a microprocessor 115, an internal memory device 120, an LCD display 130, a user interface 140, a communication port 160, and a power supply 170. The digital camera 101 may also include a removable memory card 125, a communications transceiver or system 180, and a location system 190 such as a GPS (global positioning system) chip.

The image sensor 105 captures an image through lens 102 and generates an image signal which is then digitized by the A/D (analog to digital) converter 109. The digitized signal is converted to a RAW data image file and stored in internal memory 120. A liquid crystal display (LCD) 130 is customarily provided for displaying the view through lens 102, the captured and stored images, and other information for the user. A user interface 140 is provided enabling the user to make various selections including image format. In the preferred embodiment, the user interface primarily consists of input buttons which work in combination with the LCD display 130. The internal memory device 120 may consist of a dynamic RAM memory device for storing software for the operation of the camera 101 as well as storing captured images. A microprocessor 115 is provided and controls the operation of the camera 101.

The camera 101 might also include an additional removable memory card 125. The camera 101 would also include a communication port 160 for connecting with a PC or other device for downloading images as well as uploading software updates or images. The camera also includes a power supply 170 which in the preferred embodiment consists of a battery cell or pack such as a rechargeable Lithium ion battery.

The digital camera 101 might also include a communications transceiver or system 180 used for wireless communication. Such communication may be direct to a personal computer, through a WiFi network, or over cellular or satellite communications. In addition, the camera 101 might include a location device 190 such as a GPS device for pinpointing the location of the camera when images are captured, for use as a mapping device, or for use to recover the camera if it is lost of stolen. Still further, the camera could be a component of a multifunctional device such as a wireless phone, such as a cell phone or wifi phone, or a portable music player. Current trends are pushing towards an all in one device which would include a wireless phone, music player, video player, camera, text messaging, and e-mail system. The process, system and method of the present invention could be employed in a multi-functional device and would still be envisioned under the scope of the invention.

The camera 101 is provided with software resident on the camera 101 which both operates the camera and provides the user various options. In the preferred embodiment of the present invention, the software includes an option enabling the user to select to store the same captured image in multiple formats and/or sizes. One feature of the formats and style options of the present invention is intended to enable users to capture an image and save it as high quality RAW or JPEG file while simultaneously (or sequentially) saving a much smaller JPEG file which might be ideally suited for electronic transmission for use in e-mail or uploading to photo share websites or photo printing service sites. In addition to file format options such as RAW, high-quality or e-mail quality JPEG, the camera 101 of the present invention could also allow users to process different styles or sizes. For example, the user could select to capture an image and have it processed and saved by the camera 101 as a color image, a black and white image, a sepia image, a landscape image, as well as various sizes (i.e. 4:3, 4×6, 5×7, and 8×10). The camera 101 would capture the image and process the image in the user selected formats, styles, and sizes. The camera 101 may capture and store the image data and then process the various selected formats, styles, and sizes simultaneously, in a sequential order, or any logical order deemed efficient for the software and camera 101.

By processing and storing the image in multiple formations, the present invention would eliminate the need to post process the image file on a PC after the photograph is taken. A typical size for such an image file suitable for e-mailing would be 640 pixels×480 pixels, commonly referred to in the computer industry as VGA, and at a resolution of 72 dpi which matches the typical resolution of computer monitors. For a photographer wishing to upload or send a large number of images in an e-mail, an additional in-camera option to choose a smaller file size of 320×240 pixels is desirable. The VGA size of 640×480 and the smaller size of 320×240 are merely exemplary as they are standards in the computer industry and the 320×240 size represents an ideal size for electronic transmission in e-mails and over the internet.

It should also be noted that RAW and JPEG file formats are used to describe the standard formats used today throughout the photography industry. It is possible that new file formats will replace these in future digital cameras and the RAW and JPEG file descriptions used herein is not meant to limit the invention to only these file formats.

FIG. 2 provides a flowchart depicting the steps performed by the camera for processing the captured image into two or more formats or styles. In step 210 the image is captured and then converted by the A/D converter in step 212 into a RAW data image file. The raw data image file is then saved in step 213. The camera then checks the user selected options in step 214. The camera could check the user selected options at any point in the process including prior to capturing the image. If the camera, in step 216, determines the user has NOT selected more than one format or style the camera processes and converts the captured image in to the default or user selected format and style in step 220. The camera would then perform and additional in-camera processing selected by the user in step 230 and would apply an appropriate file naming structure to the file based on format and style in step 240. The file is then saved in step 290.

Provided the camera, in step 216, determines the user has selected two or more formats or style options the camera would simultaneously or sequentially processes and convert the captured image into a first user selected format in step 221, a second user selected format in step 222, continuing until the last format or style is processed in step 223. After processing the images in the user selected formats, the camera would then perform and additional in-camera processing selected by the user in steps 231, 232, and 233 respectively. The camera would then apply an appropriate file naming structure to the files based on format and style in steps 241, 242, and 243 respectively. The files are then saved in step 290. The files could be saved in appropriate folders for the various formats and styles for file management. In step 291, the camera could then transmit selected images or image formats electronically through the communication port or wireless transceiver. The process would continue for each image captures, step 210, until the user powers down the camera ending the process as seen in step 299.

The present invention provides a way for the user of the camera of the present invention to capture and process the image on the camera directly from the captured image. This provides several significant benefits. First, the present invention enables the various formats and styles to be processed directly from the original captured image data. Some systems require the user to select one format (i.e. high quality JPEG) which is then downloaded to the user's PC where the user would be forced to post process additional formats or styles from the first selected format and not from the original raw image data. Additionally, with improvements in memory size available on internal and removable memory users will be able to store many more images. Therefore, users will be able to capture many formats and styles and then determine later which format and styles from each captured image to keep and which to delete. Further, the camera also provides the user the ability to have one file control other files such that if the user selects to delete the control file it would automatically delete all corresponding files processed into other formats. The control file feature would allow the photographer to more easily delete the various on camera images stemming from the same initial image even though processed in more than one format and possibly stored in different folders. Many users may prefer this method as capturing many formats and styles of the images and then deleting files is easier then post processing individual files.

Still further, the ability to capture and save images in formats for selected functions such as high quality and e-mail quality images provides an efficient process and system for the user.

A simple way to resize image files, to accommodate for varying aspect ratios of the image chip of different cameras, without worrying about aspect ratios and X and Y image dimensions is to instruct the software to set the longest dimension, either X or Y to a certain value, and then the shorter dimension will automatically scale to keep the aspect ratio the same. Another advantage of using the longest dimension to resize an image is that the camera does not need to know if an image was taken in landscape (wide) or portrait (tall) mode, it simply resizes the longest dimension to the predetermined size, then adjusts the shorter side to keep the aspect ratio the same as in the original photograph. For example, the digital camera can have two size options for saving e-mail compatible JPEG files where the longest dimension would be set to approximately 640 pixels for the larger file and 320 for the smaller file. The user does not then need to worry about the other dimension of the image or the resolution. This is also useful because the aspect ratios of camera imaging chips vary by camera so that it is not always possible to reduce an image from a given camera neatly to a 640×480 size without cropping some portion of the image. By reducing the longest dimension of an image to 640 or 320 pixels and automatically resizing the shortest dimension to whatever value is required to keep the aspect ration constant, no cropping of the image is required. To simplify the description of the invention, the smaller files created in the camera for the purposes of e-mailing will herein be referred to as “E” files.

As mentioned above in conjunction with FIG. 2, the camera 101 could provide additional options for in-camera processing of the files such as performing a post-resize sharpening on the image to improve the perceived sharpness of the image which is an ideal option for image formats suited for e-mail or electronic transmission. Additional in-camera processing is desirable for several reasons. First, when an image is reduced in size, data from the image must be removed in order to make a smaller file. Since the smaller file contains less information, it can appear out of focus. Second, it is common practice when processing digital images to apply a sharpening algorithm to the image after it has been resized. The sharpening algorithm results in a sharper image than if the image were sharpened before resizing. Therefore it would be undesirable for the camera to save the large JPEG file with the sharpening algorithm applied and then save the smaller file without any subsequent sharpening.

The camera of the present invention also provides a software application for handling potential naming issues. Cameras typically create sequential numerical file names when writing a file to the storage device. When a file sized for e-mail is saved concurrent with a larger resolution file it is ideal to have the smaller or e-mail file named in such a way as to easily differentiate it from the larger file. One method would be to use the same numerical file name but add an alphabetical character, for example the letter “E”m at the beginning or end of the file name to designate it as a file for use in e-mail. If the camera has the option of saving two sizes of the e-mail file, the alphabetical characters could be written as “EL” for the large e-mail file and “ES” for the small e-mail file, for example. Since files of this size would take up relatively little room in a camera's memory it would not place a severe limit on the number of photographs that can be taken at high resolution.

The addition of the small e-mail compatible JPEG file would save the photographer time not needed to process images for sending by e-mails; the designated “E” files would simply be downloaded from the camera and attached to an e-mail. It would also be desirable for the camera to create two separate folders so that large files are stored in one folder and the reduced “E” files are stored in a different folder labeled for e-mail. Having separate file folders would make it easier to keep track of the images after they are downloaded to a computer. Having all the “E” files in a separate folder would also greatly simplify sending images by e-mail since the user could just attach the entire folder to an e-mail and send it. The naming application and structure would also apply to different styles such that black and white images might use “BW” and sepia images much use “S” at the beginning or end of a file name. Further, the various naming formats could be combined such that an e-mail sized image in black and white could have “E-BW” added to the file name.

As seen in FIG. 1, the camera 101 might include a transceiver or communications system 180 such as a WiFi, cellular, satellite, RF or Bluetooth device enabling the camera to communicate and connect with a personal computer, LAN or WAN, WiFi network, and possibly the internet (world wide web). The transceiver 180 would enable the camera to wirelessly download the stored image files to a computer, or transmit files electronically via e-mail or through an upload process to some destination on the internet. Sending large files on such networks takes up a lot of bandwidth and can tie up network and device resources making such processes very expensive. Therefore, making the option to save captured images in both high quality and e-mail quality images would make it faster and cheaper to send photos on such networks.

Another feature of the present invention provides for file management through various automated processes or user selected automated processes. When the user selects to save high quality images in conjunction with e-mail or thumbnail sized images the use may also select to have the e-mail or thumbnail sized files automatically deleted upon a receipt notification by the end destination. By way of example, as the camera wirelessly connects with a PC or WiFi network the camera initiates a process to automatically transmit the e-mail or thumbnail sized images to an internet destination such as a photo share website or personal website, or to a connected PC. After receipt by the photo destination the camera would receive an end transmission receipt thereby notifying the camera that the e-mail or thumbnail images on the camera could be automatically deleted.

Another aspect of the file management feature which works in combination with the camera's ability to save multiple formats would minimize the need to upload high quality or larger files unless the image is requested. As thumbnails, or smaller sized files, are uploaded to the photographer's website, photo share sites or the user's PC would enable the thumbnails to be viewed and selected initiating a process where a signal is then sent to the Camera prompting the camera to upload the selected high quality images. Such a system is particularly useful for photographer's working in remote locations and who are working with others to select photographs which will be used (such as with a photo shoot for a magazine, photos taken for a wedding or the like). The photographer could upload thumbnails for others to select which initiates a process to automatically upload the high quality (or selected image style or size) images directly from the camera. Once the project is over the high quality images not selected and uploaded could be deleted. Such a process would minimize the need to upload high quality images over the internet or even to the user's PC.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

Further, while the invention has been described in detail and with reference to specific embodiments thereof, it will be apparent to those skilled in the art that various changes and modifications can be made therein without departing from the spirit and scope thereof.

What is claimed is:

1. A digital camera comprising:
an image sensor for capturing an image and producing an image signal of the image;
an analog-to-digital converter for digitizing the image signal to produce a raw digital image;
an internal memory for storing at least one digital image; and
a processor for compressing the raw digital image into a first format digital image and storing the first format digital image on the internal memory and for compressing the raw digital image into a second format digital image and storing the second format digital image on the internal memory.

2. The digital camera of claim 1, wherein the processor processes the first format digital image and the second format digital image simultaneously.

3. The digital camera of claim 1, wherein the processor processes the first format digital image and the second format digital image sequentially.

4. The digital camera of claim 1, wherein the processor processes at least one aspect of the first format digital image and the second format digital image simultaneously.

5. The digital camera of claim 1, wherein the processor processes at least one aspect of the first format digital image and the second format digital image sequentially.

6. The digital camera of claim 1, wherein the processor applies a first file name to the first format digital image and a second file name to the second format digital image.

7. The digital camera of claim 1 further comprising:
a display coupled to the internal memory for displaying at least one digital image stored on the internal memory; and
a user interface for selecting a first format for the first format digital image and a second format for the second format digital image.

8. The digital camera of claim 7, wherein at least one of the first format digital image or the second format digital image is formatted for electronic transmission over a communication line.

9. The digital camera of claim 7, wherein the user interface provides a file management unit which can delete the first format digital image and the second format digital image through one user selection.

10. A method for capturing, processing and storing digital images on a digital camera comprising the steps of:
capturing an image and producing an image signal representative of the image;
converting the analog image signal into a raw digital image;
determining a first format and a second format from user selected format options;
processing the raw digital image into a first format digital image and a second format digital image;
naming the first format digital image with a first name and the second format digital image with a second name; and
storing the first format digital image and the second format digital image on a memory in the camera.

11. The method of claim 10 further comprising the step of wirelessly transmitting at least one of the first format digital image or the second format digital image to a computer.

12. The method of claim 10 further comprising the step of electronically transmitting at least one of the first format digital image or the second format digital image over the internet.

13. The method of claim 10 further comprising the step of applying an additional processing step to at least one of the first format digital image or the second format digital image.

14. The method of claim 10, wherein the second format digital image is processed simultaneously with the processing of the first format digital image.

15. The method of claim 10, wherein the second format digital image is processed after the processing of the first format digital image.

16. The method of claim 10, further comprising the steps of deleting the first format digital image and the second format digital image from instructions based on one user selected option.

17. A digital camera comprising:
an image sensor for capturing an image and producing an image signal of the image;
an analog-to-digital converter for digitizing the image signal to produce a raw digital image;
an internal memory for storing at least one digital image; and
a processor for compressing the raw digital image into a first format digital image and storing the first format digital image on the internal memory and for compressing the raw digital image into a second format digital image and storing the second format digital image on the internal memory;
wherein the processor applies a first file name to the first format digital image and a second file name to the second format digital image;
a display coupled to the internal memory for displaying at least one digital image; and
a user interface for selecting a first format for the first format digital image and a second format for the second format digital image, wherein the user interface provides a file management unit which can delete the first format digital image and the second format digital image through one user selection.

18. The digital camera of claim 17, wherein the processor processes the first format digital image and the second format digital image simultaneously.

19. The digital camera of claim 17, wherein the processor processes the first format digital image and the second format digital image sequentially.

20. The digital camera of claim 17, wherein the processor processes at least one aspect of the first format digital image and the second format digital image simultaneously.

21. The digital camera of claim 17, wherein the processor processes at least one aspect of the first format digital image and the second format digital image sequentially.

22. The digital camera of claim 17, wherein at least one of the first format digital image or the second format digital image is formatted for electronic transmission over a communication line.
